(19) United States
(12) Patent Application Publication
(10) Pub. No.: US 2011/0153655 A1
(43) Pub. Date: Jun. 23, 2011

(54) SERVER-SENSOR NETWORK COOPERATIVE SPATIAL QUERY PROCESSING METHOD AND SERVER USING THE SAME

(75) Inventors: Min-Soo KIM, Daejeon (KR); Moon-Soo Lee, Daejeon (KR); In-Hak Joo, Daejeon (KR); In-Sung Jang, Daejeon (KR); Chung-Ho Lee, Daejeon (KR); Ju-Wan Kim, Daejeon (KR); Kyung-Ok Kim, Daejeon (KR); Jong-Hyun Park, Daejeon (KR)

(73) Assignee: Electronics and Telecommunications Research Institute, Daejeon (KR)

(21) Appl. No.: 12/973,203

(22) Filed: Dec. 20, 2010

(30) Foreign Application Priority Data
Dec. 21, 2009 (KR) 10-2009-0128412

(51) Int. Cl. G06F 17/30

(52) U.S. Cl. 707/769; 707/E17.014

(57) ABSTRACT

Disclosed herein are a server-sensor network cooperative spatial query processing method and a server using the method. The server-sensor network cooperative spatial query processing method includes the server detecting supplementary information for selecting sensor nodes to be excluded from among a plurality of sensor nodes by performing a preliminary spatial query, before starting a spatial query with the plurality of sensor nodes, and the server requesting the spatial query to the sensor nodes, selected based on the supplementary information, when starting the spatial query with the plurality of sensor nodes.

### CROSS REFERENCE TO RELATED APPLICATIONS

This application claims the benefit of Korean Patent Application No. 10-2009-0128412 filed on Dec. 21, 2009, which is hereby incorporated by reference in its entirety into this application.

### BACKGROUND OF THE INVENTION

1. Field of the Invention

The present invention relates generally to a server-sensor network cooperative spatial query processing method and a server using the method, which are capable of extending the life span of sensor nodes, and, more particularly, to a server-sensor network cooperative spatial query processing method which, when a spatial query is given in a sensor network environment, searches for sensor nodes satisfying a spatial query condition while minimizing the energy consumption of sensor nodes, and enables a server to acquire the sensed information of the found sensor nodes, and a server using the method.

2. Description of the Related Art

In general, the simplest method of performing sensor network-based spatial query processing is the centralized method. In the centralized method, a server acquires pieces of sensed/position information from all sensor nodes and then performs a spatial query. In the centralized method, however, the server accesses all the sensor nodes in order to acquire all the pieces of sensed/position information. That is, the centralized method is disadvantageous because the number of times that wireless communication is performed is greatly increased by the process of accessing all the sensor nodes.

In order to overcome the disadvantage of the conventional centralized method, an in-network spatial query processing method was proposed. The in-network spatial query processing method employs a method in which a spatial query is not performed by a server, but is distributed across a sensor network and then processed. In such in-network spatial query processing methods, in order to increase efficiency when the spatial query is distributed across and performed by sensor nodes, a distributed spatial index method is chiefly used. More particularly, in the in-network spatial query processing method, a spatial search for the sensor nodes is performed using a distributed spatial index. Furthermore, based on the spatial search results, access to sensor nodes not satisfying a spatial query condition is not performed. As described above, the in-network spatial query processing method reduces the total number of times that wireless communication required to perform the spatial query is performed, as compared to the former conventional technology.

Even in the in-network spatial query processing method, however, dead space inevitably is formed within the distributed spatial index constructed in the sensor network environment. This dead space is unfortunately problematic in that it causes unnecessary wireless communication when the distributed spatial query is performed. Furthermore, the dead space tends to further increase in the distributed spatial index of the sensor network environment.

FIG. 1 is a diagram showing a common distributed spatial index constructed by applying the existing R-tree spatial index concept to a sensor network and spatial search objects given in a square form. FIG. 1 shows a server 100, a base station 110, sensor nodes 120, a distributed spatial index structure 130 for supporting efficient spatial queries, spatial search objects 140, and wireless communication 150 between the sensor nodes.

Referring to FIG. 1, the conventional in-network spatial query processing method is problematic in that sensor nodes having no actual results are unnecessarily accessed. For example, it is assumed that the four spatial search objects 140 including α, β, γ, and δ are given for a spatial query. When a spatial search for the sensor nodes is performed, the sensor nodes Nos. 7 and 8 are unnecessarily accessed even when the sensor node No. 7 does not have any actual results. This is because there is an overlap of the spatial search object β between the Minimum Bounding Rectangle (MBR) 130 (i.e., the distributed spatial index structure of the sensor node No. 7) and the spatial search objects 140. Furthermore, in the conventional in-network spatial query processing method, the sensor node No. 5 within the spatial search object α is unnecessarily access. This is because there is an overlap with the MBR (i.e., the spatial index structure of the sensor node No. 5).

Unlike in the conventional centralized method in which the server performs the entire spatial query, in the conventional in-network spatial query processing method, the spatial query processing is not performed by the server, but is distributed into the sensor network and then performed. Accordingly, the number of times that wireless communication required for processing the spatial query is performed between the sensor nodes may be reduced. The conventional in-network spatial query processing method has the advantage of reducing the number of times that wireless communication is performed as described above, but still has a problem in that unnecessary wireless communication with the sensor nodes Nos. 5, 7, and 8 of FIG. 1 may not be removed.

In other words, the conventional in-network spatial query processing method has the problem of performing unnecessary wireless communication with sensor nodes having no actual spatial search results. Such unnecessary wireless communication may be more frequently performed in a sensor network environment with lots of dead spaces. Here, the term “dead space” refers to an area which is included in a distributed spatial index structure, but does not actually have information. The number of dead spaces may be greatly increased in the sensor network environment. This is because wireless communication between the sensor nodes included in the distributed spatial index structure does not actually include information, unlike the sensor nodes.

### SUMMARY OF THE INVENTION

Accordingly, the present invention has been made keeping in mind the above problems occurring in the prior art, and an object of the present invention is to provide a server-sensor network cooperative spatial query processing method which, when a spatial query is given in a sensor network environment, searches for sensor nodes satisfying a spatial query condition while minimizing the energy consumption of sensor nodes and enables a server to acquire the sensed information of the found sensor nodes, and a server using the method.

In order to accomplish the above object, the present invention provides a server-sensor network cooperative spatial query processing method, including the server detecting supplementary information for selecting sensor nodes to be excluded from among a plurality of sensor nodes by performing a preliminary spatial query, before starting a spatial query with the plurality of sensor nodes; and the server requesting the spatial query to the sensor nodes, selected based on the supplementary information, when starting the spatial query with the plurality of sensor nodes.

The supplementary information may include information about the positions of sensor nodes detected as results of the preliminary spatial query, information about spatial search objects having no results of the preliminary spatial query, and/or information about sensor nodes having no results of the preliminary spatial query.

The server detecting the supplementary information may include the server sending the preliminary spatial query before starting the spatial query with the plurality of sensor nodes; and detecting the supplementary information for selecting sensor nodes to be excluded from among the plurality of sensor nodes based on results of the preliminary spatial query.

The preliminary spatial query may search for sensor nodes satisfying the preliminary spatial query based on spatial index information including information about positions of the plurality of sensor nodes.

The providing query/filtering information may include providing the supplementary information to the plurality of sensor nodes; and requesting the spatial query to the selected sensor nodes based on the supplementary information.

The providing the supplementary information may include the server providing information about the positions of the sensor nodes to the sensor nodes when the information about the positions of the sensor nodes which is results of the preliminary spatial query is used as the supplementary information.

The providing the supplementary information may include the server providing information about spatial search objects, other than information about spatial search objects having no results of the preliminary spatial query, to the sensor nodes when the information about the spatial search objects having no results of the preliminary spatial query is used as the supplementary information.

The providing the supplementary information may include the server providing information about sensor nodes having no results of the preliminary spatial query, together with information about spatial search objects having no results of the preliminary spatial query, to the sensor nodes when the information about the spatial search objects and the information about the sensor nodes having no results of the preliminary spatial query are simultaneously used as the supplementary information.

The requesting the spatial query to the selected sensor nodes may include the server excluding the sensor nodes having no results of the preliminary spatial query when performing the spatial query using the spatial search objects.

Additionally, in order to accomplish the above object, the present invention provides a server for performing server-sensor network cooperative spatial query processing, including a preliminary query execution unit for detecting supplementary information for selecting sensor nodes to be excluded from among a plurality of sensor nodes by performing a preliminary spatial query, before starting a spatial query with the plurality of sensor nodes; and a query/filtering information provision unit for requesting the spatial query to the sensor nodes, selected based on the supplementary information, when starting the spatial query with the plurality of sensor nodes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a common distributed spatial index constructed by applying the existing R-tree spatial index concept to a sensor network and spatial search objects given in a square form;

FIG. 2 shows a distributed spatial index structure applied to a sensor network in order to illustrate a server-sensor network cooperative spatial query processing method according to the present invention;

FIGS. 3A and 3B are a schematic diagram of the entire system to which the server-sensor network cooperative spatial query processing method according to the present invention is applied;

FIG. 4 is a diagram schematically showing the internal configuration of the server shown in FIG. 3;

FIG. 5 is a diagram schematically showing the internal configuration of a base station and sensor nodes shown in FIG. 3; and

FIG. 6 is a diagram showing the flow of the server-sensor network cooperative spatial query processing method according to the present invention.

### DESCRIPTION OF THE PREFERRED EMBODIMENTS

Reference now should be made to the drawings, in which the same reference numerals are used throughout the different drawings to designate the same or similar components.

Embodiments of the present invention will be described in detail with reference to the accompanying drawings.

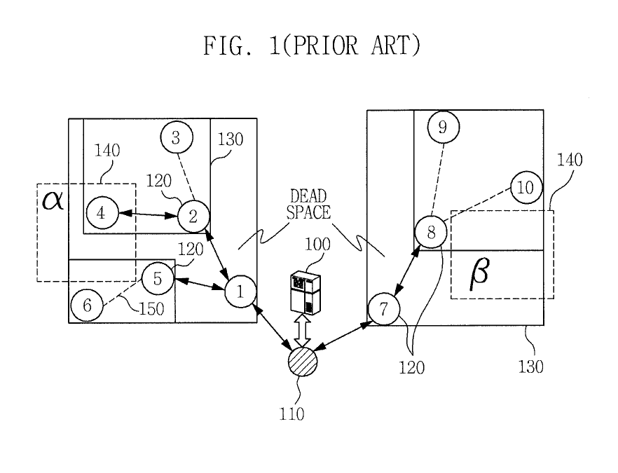

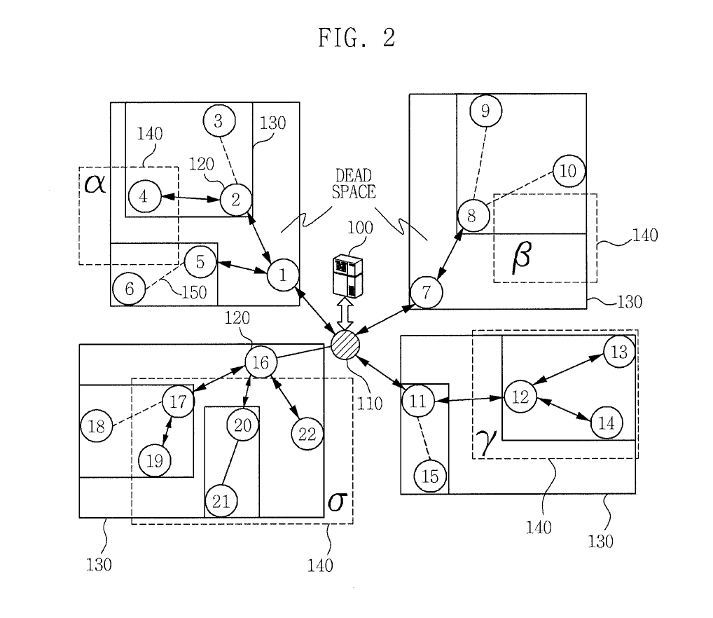

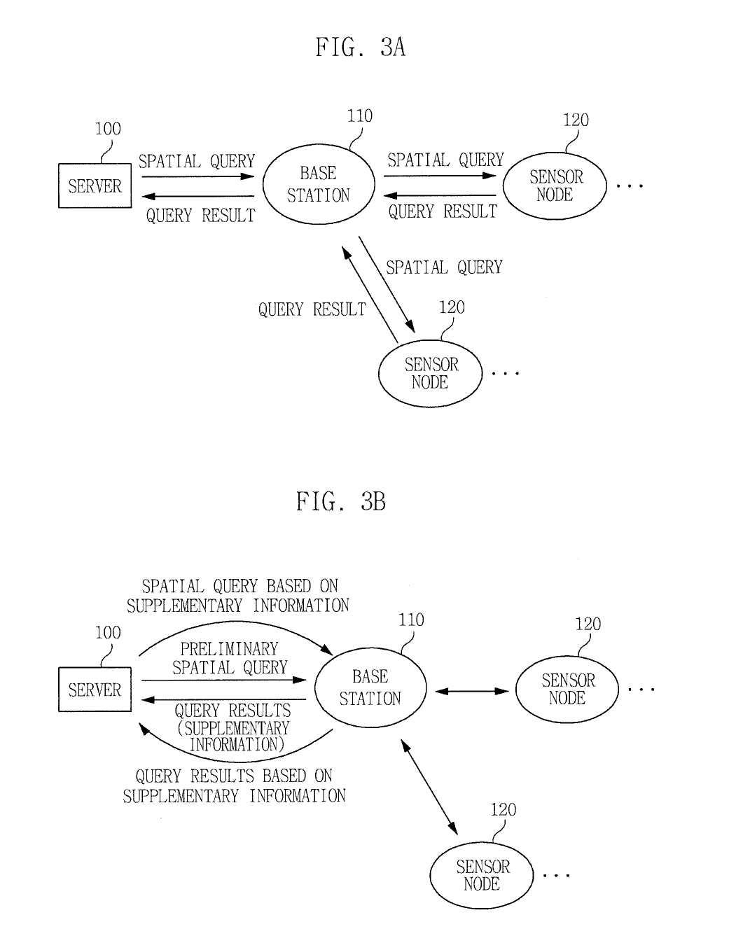

FIG. 2 shows a distributed spatial index structure applied to a sensor network in order to illustrate a server-sensor network cooperative spatial query processing method according to the present invention. FIG. 3 is a schematic diagram of the entire system to which the server-sensor network cooperative spatial query processing method according to the present invention is applied. As in FIG. 1, in FIG. 2, a common distributed spatial index constructed by applying the existing R-tree spatial index concept to a sensor network and spatial search objects given in a square form are shown together. Hereinafter, reference numeral 130 denotes a distributed spatial index structure for supporting an efficient spatial query, reference numeral 140 denotes a spatial search object for a spatial query, and reference numeral 150 denotes wireless communication between sensor nodes.

Referring to FIGS. 2 and 3, a system to which the server-sensor network cooperative spatial query processing method according to the present invention is applied includes a server 100, and a base station 110 and sensor nodes 120 which construct a sensor network.

The system includes a construction for supporting the above-described in-network-based spatial query processing process together, and a description of the construction is omitted here.

Furthermore, it is assumed that the same index information as is stored in the sensor nodes, such as distributed spatial index information, is stored in the server and operations are performed in a system in which the locations of the sensor nodes have been fixed. However, the construction of the system is only illustrative for the sake of description, and the present invention is not limited thereto.

It is also assumed that spatial query indexing between the server and the sensor network is performed on the basis of the structure of the server 100-the base station 110-the sensor nodes 120. However, the structure is only illustrative for convenience of description, but the present invention is not limited thereto.

Referring to FIG. 3A, when the common in-network spatial query processing method is used, sensor nodes having no actual results are unnecessarily accessed, thus wasting energy in the sensor network. Therefore, in the present invention, when a spatial query is given in a sensor network environment, a method of searching for sensor nodes satisfying a spatial query condition while minimizing the energy consumption of the sensor nodes, and enabling the server to acquire the sensed information of the sensor nodes is employed. In the present invention, the minimization of the energy consumption of the sensor nodes refers to the minimization of the number of times that wireless communication is performed between the sensor nodes, which occurs in the process of performing a spatial query.

Referring to FIG. 3B, in the server-sensor network cooperative spatial query processing method according to the present invention, the server performs a distributed spatial query in advance before the spatial index is performed between the server and the sensor network to search for unnecessary spatial search objects within the sensor network and supplementary information about sensor nodes that should not be actually visited.

An example of the unnecessary spatial search objects may be the spatial search object β shown in FIG. 2. That is, it is assumed that the four spatial search objects 140 including {α, β, γ, and δ} are given in a spatial query. When a spatial search for sensor nodes is performed, the sensor nodes Nos. 7 and 8 of the sensor nodes 120 are unnecessarily accessed even though the sensor node No. 7 does not have any actual results. This is because there is an overlap of the spatial search object β between the MBR 130 (i.e., the spatial index structure of the sensor node No. 7) and the spatial search objects 140.

Furthermore, an example of a sensor node that should not be visited may be the spatial search object α shown in FIG. 2. That is, when the conventional in-network spatial query processing method is used, sensor node No. 5 of the sensor nodes 120 is unnecessarily accessed in connection with the spatial search object α of the spatial search objects 140. This is because there is an overlap of the spatial search object α between the MBR (i.e., the spatial index structure of the sensor node No. 5) and the spatial search objects 140.

For the above reasons, in the present invention, the server sends the pieces of supplementary information to the sensor nodes. In a distributed spatial index process between the server and the sensor network, the number of sensor nodes that should be actually visited is reduced on the basis of the pieces of supplementary information. As described above, the present invention operates in such a way as to reduce the total number of times that wireless communication is performed.

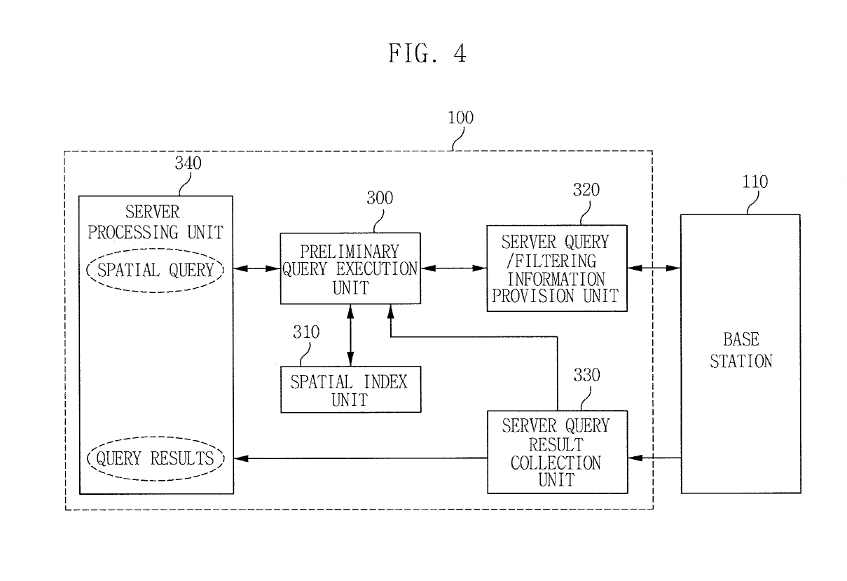

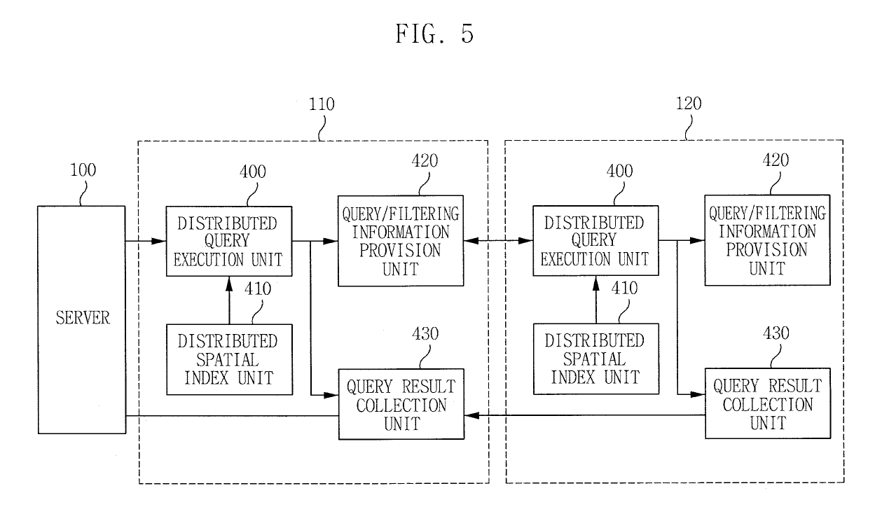

FIG. 4 is a diagram schematically showing the internal configuration of the server shown in FIG. 3, and FIG. 5 is a diagram schematically showing the internal configuration of the base station and the sensor nodes shown in FIG. 3.

Referring to FIG. 4, the server 100 of the present invention includes a preliminary query execution unit 300, a spatial index unit 310, a server query/filtering information provision unit 320, a server query result collection unit 330, and server processing unit 340.

The server processing unit 340 generates a spatial query in the sensor network, receives query results in response to the spatial query, and provides the query results to a user. The spatial query may be input by a user or automatically generated by software set aside for this purpose. Furthermore, any construction may be used as the server processing unit 340 as long as it can generate a spatial query and receive and process a query result.

The preliminary query execution unit 300 performs a preliminary spatial query before performing distributed spatial indexing in response to the input spatial query. The execution of the preliminary spatial query is a process of searching for sensor nodes satisfying a spatial query condition. The process is performed on the basis of spatial index information of the spatial index unit 310. The present invention is applied to fixed sensor nodes. Here, the server can store spatial index information (e.g., a sensor node ID and information about the position of a sensor node) about sensor nodes, and a preliminary spatial query may be easily processed.

Furthermore, in the process of performing the preliminary spatial query, the preliminary query execution unit 300 extracts pieces of supplementary information which may be efficiently used when a distributed spatial query is performed in the sensor network in the future. The pieces of supplementary information include pieces of information about the positions of sensor nodes (i.e., results of a preliminary spatial query), information about spatial search objects having no results of a preliminary spatial query, and information about sensor nodes including no actual results of the preliminary spatial query even though the sensor nodes are visited. The pieces of supplementary information are used to reduce unnecessary access to sensor nodes when the distributed spatial query is performed between the server and the sensor network.

The server query/filtering information provision unit 320 functions to analyze and convert the generated spatial query and to send the converted spatial query to the sensor network. The server query result collection unit 330 functions to collect query results collected from the sensor network and to transfer them.

Furthermore, the server query/filtering information provision unit 320 changes a spatial query method on the basis of the supplementary information extracted by the preliminary query execution unit 300 when processing the generated spatial query, and then performs the changed spatial query method. That is, when information about spatial search objects having no results of a preliminary spatial query is used as the supplementary information, the server query/filtering information provision unit 320 sends information about the remaining spatial search objects other than the information about the spatial search objects having no results of the preliminary spatial query, when sending the converted spatial query to the sensor network. For example, as shown in FIG. 2, only the spatial search objects α, γ, and δ other than the spatial search object β have to be sent to the sensor network. In this case, a spatial search for the sensor nodes Nos. 7 and 8 may not be performed.

Furthermore, when information about spatial search objects having no results of a preliminary spatial query, and information about sensor nodes actually having no results of the preliminary spatial query even though the sensor nodes are visited are used as the supplementary information at the same time, the server query/filtering information provision unit 320 sends spatial query information, including the information about the sensor nodes actually having no results of the preliminary spatial query even though the sensor nodes are visited, together with information about the spatial search objects α, γ, and δ, to the sensor network. Accordingly, when performing a predetermined spatial query using the spatial search objects α, γ, and δ, the distributed query execution unit 400 of the sensor node 120 no longer propagates the execution of the spatial query to the child sensor node if the child sensor node is included in the sensor nodes having no results of the preliminary spatial query even though they are visited, even though the spatial query has to be propagated to a child sensor node because of a spatial overlap between the spatial search objects α, γ, and δ and spatial index information about the child sensor node. That is, information about sensor nodes which seem to include results of the preliminary spatial query in a spatial search process using a spatial index when a preliminary spatial query is performed but do not actually include the results of the preliminary spatial query is used. In this case, neither spatial search for the sensor nodes Nos. 7 and 8 nor spatial search for the sensor node No. 5 is performed.

As described above, in the present invention, the server searches for unnecessary spatial search objects and supplementary information about sensor nodes that should not be actually visited, by performing a preliminary spatial query before performing distributed spatial search. The server 100 reduces the number of times that wireless communication is performed between sensor nodes in the process of processing the spatial query on the basis of the supplementary information.

Referring to FIG. 5, each of the sensor nodes 120 (including the base station 110) constituting the sensor network includes a distributed query execution unit 400, a distributed spatial index unit 410, a query/filtering information provision unit 420, and a query result collection unit 430.

The distributed query execution unit 400 functions to determine whether a current sensor node satisfies a predetermined spatial query condition. If it is determined that the sensor node satisfies the spatial query condition, the distributed query execution unit 400 stores the sensed/position information of the sensor node in the server query result collection unit 430. Furthermore, the distributed query execution unit 400 functions to determine whether the child sensor nodes of the sensor node satisfy the spatial query condition in advance. If it is determined that the child sensor nodes satisfy the spatial query condition, the distributed query execution unit 400 stores the spatial query, currently being performed, in the query/filtering information provision unit 420 in order to propagate the spatial query to the child sensor nodes. Here, the spatial index information of the distributed spatial index unit 410 is used to determine whether the child sensor nodes satisfy the spatial query condition.

The query/filtering information provision unit 420 functions to propagate the stored spatial query to the child sensor nodes. The query result collection unit 430 functions to send information about the results of the spatial query, collected by himself and information about results of the spatial query, collected from the child sensor nodes, to a higher-ranking parent sensor node. If a specific sensor node does not satisfy a preliminary spatial query condition and its child sensor nodes do not satisfy the preliminary spatial query condition, the specific sensor node does not propagate a spatial query to the child sensor nodes and does not send the results of the preliminary spatial query condition to its parent sensor node. Accordingly, the total number of times wireless communication is performed can be reduced.

Meanwhile, when performing a spatial query, the distributed query execution unit 400 changes the above spatial query method on the basis of the supplementary information received from the server. That is, when position information about the corresponding sensor node (i.e., the results of the preliminary spatial query) is used as the supplementary information, the distributed to query execution unit 400 performs the spatial query on the basis of the information about the position of the sensor node (i.e., the actual results of the preliminary spatial query) other than a spatial search object given in the spatial query. When the spatial search is performed on the basis of the accurate information about the position of the sensor node (i.e., the results of the preliminary spatial query) as described above, there is an advantage in that a spatial search for dead space, such as a search based on a spatial search object, is not performed. For example, in FIG. 2, if not spatial search based on the spatial search objects α, β, γ, and δ, but spatial search based on the sensor nodes Nos. 4, 12, 13, 14, 17, 19, 20, 21, and 22 (i.e., the results of the preliminary spatial query) is performed, spatial search for the sensor nodes Nos. 5, 7, and 8 may not be performed. Here, the query/filtering information provision unit 420 has to send the information about the position of the sensor node (i.e., the results of the preliminary spatial query), not the spatial search object, to the child sensor nodes as information for the spatial query and filtering. This method has the risk of greatly increasing the amount of information that must be sent to the sensor network.

Furthermore, when information about a spatial search object having no results of the preliminary spatial query and information about a sensor node having no results of the preliminary spatial query even though the sensor node is visited are simultaneously used as the supplementary information, the distributed query execution unit 400 receives spatial query information, including the information about the sensor node having no results of the preliminary spatial query even though the sensor node is visited, together with the information about the spatial search objects α, γ, and δ from the server query/filtering information provision unit 320. Accordingly, when performing a predetermined spatial query using the spatial search objects α, γ, and δ, the distributed query execution unit 400 of the sensor node 120 no longer propagates the execution of the spatial query to the child sensor node if the child sensor node is included in the sensor node having no results of the preliminary spatial query even though the child sensor is visited, even though the spatial query has to be propagated to a child sensor node because of a spatial overlap between the spatial search objects α, γ, and δ and spatial index information about the child sensor node. In this case, neither spatial search for the sensor nodes Nos. 7 and 8 nor spatial search for the sensor node No. 5 is performed.

Hereinafter, a server-sensor network cooperative spatial query processing method according to the present invention is described in detail with reference to the accompanying drawings.

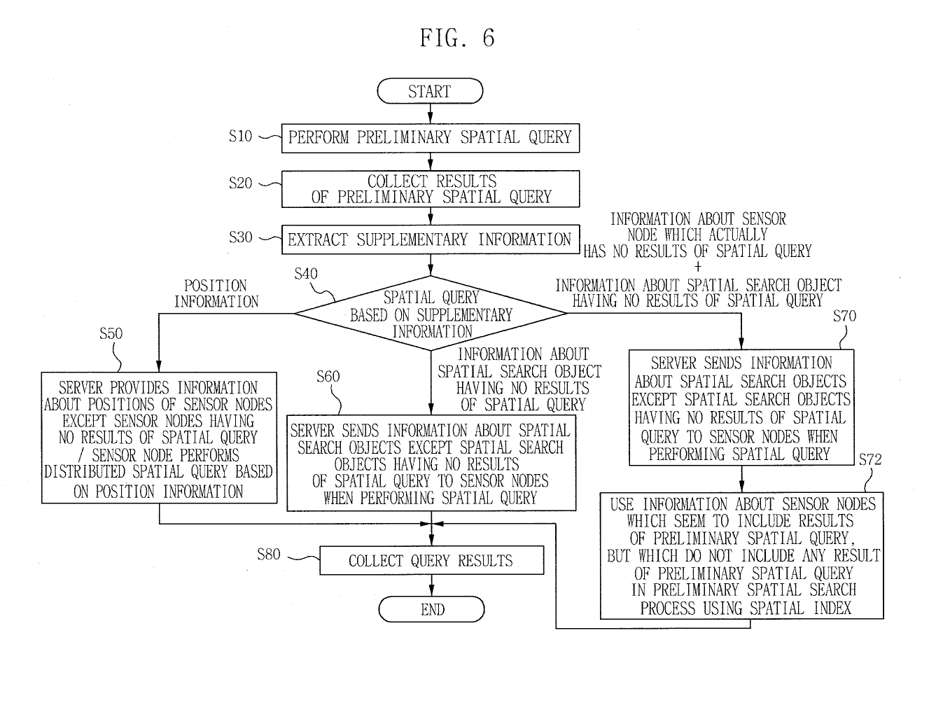

FIG. 6 is a diagram showing the flow of the server-sensor network cooperative spatial query processing method according to the present invention. In the description, it is assumed that the sensor nodes have a fixed position.

Referring to FIG. 6, first, the preliminary query execution unit 300 of the server 100 performs a preliminary spatial query at step S10. The execution of the preliminary spatial query as described above is a process of searching for sensor nodes satisfying a spatial query condition. The process is performed on the basis of spatial index information of the spatial index unit 310. Here, the query/filtering information provision unit 320 analyzes the preliminary spatial query generated by the preliminary query execution unit 300, converts the analyzed preliminary spatial query, and sends the converted spatial query to the sensor network.

After the preliminary spatial query has been generated, the server query result collection unit 330 of the server collects query results from sensor nodes at step S20. Furthermore, in the process of performing the preliminary spatial query, the preliminary query execution unit 300 extracts pieces of supplementary information which may be efficiently used when a distributed spatial query is performed in the sensor network in the future at step S30.

The server query/filtering information provision unit 320 performs a spatial query using the pieces of supplementary information at step S40. That is, the server query/filtering information provision unit 320 performs a distributed spatial index on the basis of the pieces of supplementary information extracted between the server and the sensor network.

As described above, the pieces of supplementary information include pieces of information about the positions of sensor nodes (i.e., the results of a preliminary spatial query), information about spatial search objects having no results of the preliminary spatial query, and information about sensor nodes including no actual results of the preliminary spatial query even though the sensor nodes are visited. The pieces of supplementary information may be used to reduce unnecessary access to sensor nodes when the distributed spatial query is performed in the sensor network.

When the pieces of information about the positions of sensor nodes (i.e., the results of the preliminary spatial query) are used as the supplementary information at step S40 will now be described.

When performing a spatial query, the distributed query execution unit 400 performs the spatial query on the basis of not the spatial search object given in the spatial query but information about the position of a sensor node (i.e., the actual result of the preliminary spatial query), at step S50. If the spatial search is performed on the basis of accurate information about the position of the sensor node (i.e., the result of the preliminary spatial query) as described above, there is an advantage in that spatial search for dead space, such as search based on spatial search objects, is not performed. For example, in FIG. 2, if spatial search based on the sensor nodes Nos. 4, 12, 13, 14, 17, 19, 20, 21, and 22 (i.e., results of the preliminary spatial query), other than spatial search based on the spatial search objects α, β, γ, and δ, is performed, spatial search for the sensor nodes Nos. 5, 7, and 8 may not be performed. Here, the query/filtering information provision unit 420 of the sensor node 120 has to send the information about the position of the sensor node (i.e., the result of the preliminary spatial query), other than the spatial search object, to the child sensor nodes as information for the spatial query and filtering. This method has the risk of greatly increasing the amount of information that must be sent to the sensor network.

Meanwhile, the case where the information about spatial search objects having no results of the preliminary spatial query is used as the supplementary information at step S40 will now be described. The query/filtering information provision unit 320 of the server 100 sends information about the remaining spatial search objects, other than the information about the spatial search objects having no results of the preliminary spatial query, to the sensor network when sending the converted spatial query to the sensor network at step S60. For example, as shown in FIG. 2, only the spatial search objects α, γ, and δ, other than the spatial search object β, have to be sent to the sensor network. Here, spatial search for the sensor nodes Nos. 7 and 8 may not be performed.

Meanwhile, the case where the information about spatial search objects having no results of the preliminary spatial query and the information about the sensor nodes having no results of the preliminary spatial query even though the sensor nodes are visited are used as the supplementary information at the same time (i.e., when information included in the results of the preliminary spatial query, but included in the information about the sensor nodes actually having no results of the preliminary spatial query is used) at step S40 will now be described. The server query/filtering information provision unit 320 of the server 100 sends spatial query information, including the information about the sensor nodes having no results of the preliminary spatial query even though the sensor nodes are visited, together with the information about the spatial search objects α, γ, and δ, to the sensor network at step S60. When performing a predetermined spatial query using the spatial search objects α, γ, and δ, the distributed query execution unit 400 of the sensor node 120 no longer propagates the execution of the spatial query to the child sensor node at step S72 if the child sensor node is included in the sensor nodes having no results of the preliminary spatial query even though they are visited, even though the spatial query has to be propagated to a child sensor node because of a spatial overlap between the spatial search objects α, β, and δ and spatial index information about the child sensor node. In this case, neither spatial search for the sensor nodes Nos. 7 and 8 nor spatial search for the sensor node No. 5 is performed.

After finishing distributed query execution, query results are collected at step S80.

As described above, in the server-sensor network cooperative spatial query processing method according to the present invention, the server performs a spatial query in advance and extracts various pieces of supplementary information as described above, and a distributed spatial query is performed in the sensor network on the basis of the pieces of supplementary information. Accordingly, unnecessary access to sensor nodes can be prevented, and therefore the total number of times wireless communication is performed between the sensor nodes can be reduced.

In accordance with the present invention, in an in-network-based spatial query processing process, a predetermined spatial query is cooperatively processed between the server and the sensor nodes of a sensor network. Accordingly, there is an advantage in that unnecessary wireless communication is not performed.

Furthermore, there are advantages in that the energy consumption of sensor nodes is reduced and the lifespan thereof is increased because of a reduction in the number of times that wireless communication is performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A server-sensor network cooperative spatial query processing method, comprising:
detecting supplementary information for selecting sensor nodes to be excluded from among a plurality of sensor nodes by performing a preliminary spatial query, before starting a spatial query with the plurality of sensor nodes; and
requesting the spatial query to the sensor nodes, selected based on the supplementary information, when starting the spatial query with the plurality of sensor nodes.

2. The method as set forth in claim 1, wherein the supplementary information comprises information about positions of sensor nodes detected as results of the preliminary spatial query, information about spatial search objects having no results of the preliminary spatial query, and/or information about sensor nodes having no results of the preliminary spatial query.

3. The method as set forth in claim 1, wherein the detecting the supplementary information comprises:
sending the preliminary spatial query before starting the spatial query with the plurality of sensor nodes; and
detecting the supplementary information for selecting sensor nodes to be excluded from among the plurality of sensor nodes based on results of the preliminary spatial query.

4. The method as set forth in claim 3, wherein the preliminary spatial query is used for searching for sensor nodes satisfying the preliminary spatial query based on spatial index information including information about positions of the plurality of sensor nodes.

5. The method as set forth in claim 1, wherein the requesting the spatial query comprises:
providing the supplementary information to the plurality of sensor nodes; and
requesting the spatial query to the selected sensor nodes based on the supplementary information.

6. The method as set forth in claim 5, wherein the providing the supplementary information comprises providing information about positions of the sensor nodes to the sensor nodes when the information about the positions of the sensor nodes which is results of the preliminary spatial query is used as the supplementary information.

7. The method as set forth in claim 5, wherein the providing the supplementary information comprises providing information about spatial search objects except spatial search objects having no results of the preliminary spatial query, to the sensor nodes when the information about the spatial search objects having no results of the preliminary spatial query is used as the supplementary information.

8. The method as set forth in claim 5, wherein the providing the supplementary information comprises providing information about sensor nodes having no results of the preliminary spatial query, together with information about spatial search objects having no results of the preliminary spatial query, to the sensor nodes when the information about the spatial search objects and the information about the sensor nodes having no results of the preliminary spatial query are simultaneously used as the supplementary information.

9. The method as set forth in claim 8, wherein the requesting the spatial query to the selected sensor nodes comprises excluding the sensor nodes having no results of the preliminary spatial query when performing the spatial query using the spatial search objects.

10. A server for performing server-sensor network cooperative spatial query processing, comprising:
a preliminary query execution unit for detecting supplementary information for selecting sensor nodes to be excluded from among a plurality of sensor nodes by performing a preliminary spatial query, before starting a spatial query with the plurality of sensor nodes; and
a query/filtering information provision unit for requesting the spatial query to the sensor nodes, selected based on the supplementary information, when starting the spatial query with the plurality of sensor nodes.

11. The server as set forth in claim 10, wherein the supplementary information comprises information about positions of sensor nodes which is results of the preliminary spatial query, information about spatial search objects having no results of the preliminary spatial query, and/or is information about sensor nodes having no results of the preliminary spatial query.

12. The server as set forth in claim 10, wherein the preliminary query execution unit sends the preliminary spatial query before starting the spatial query with the plurality of sensor nodes.

13. The server as set forth in claim 12, wherein the preliminary spatial query is used for searching for sensor nodes satisfying the preliminary spatial query based on spatial index information including information about positions of the plurality of sensor nodes.

14. The server as set forth in claim 10, wherein the query/filtering information provision unit provides the supplementary information to the plurality of sensor nodes.

15. The server as set forth in claim 14, wherein the query/filtering information provision unit provides information about the positions of the sensor nodes to the sensor nodes, when the information about the positions of the sensor nodes which is results of the preliminary spatial query is used as the supplementary information.

16. The server as set forth in claim 14, wherein the query/filtering information provision unit provides information about spatial search objects, except spatial search objects having no to results of the preliminary spatial query, to the sensor nodes, when the information about the spatial search objects having no results of the preliminary spatial query is used as the supplementary information.

17. The server as set forth in claim 14, wherein the query/filtering information provision unit provides information about sensor nodes having no results of the preliminary spatial query, together with information about spatial search objects having no results of the preliminary spatial query, to the sensor nodes, when the information about the spatial search objects and the information about the sensor nodes having no results of the preliminary spatial query are simultaneously used as the supplementary information.

18. The server as set forth in claim 17, wherein the query/filtering information provision unit excludes the sensor nodes having no results of the preliminary spatial query when performing the spatial query using the spatial search objects.
